(19) United States
(12) Patent Application Publication
(10) Pub. No.: US 2023/0081172 A1
(43) Pub. Date: Mar. 16, 2023

(54) POWER FAILURE DETECTION SYSTEM, POWER FAILURE DETECTION DEVICE, AND POWER FAILURE DETECTION METHOD

(71) Applicant: NEC Corporation, Minato-ku, Tokyo (JP)

(72) Inventors: Yukihide YODA, Tokyo (JP); Naoto OGURA, Tokyo (JP); Yoshiaki AONO, Tokyo (JP)

(73) Assignee: NEC Corporation, Minato-ku, Tokyo (JP)

(21) Appl. No.: 17/801,589

(22) PCT Filed: Jan. 18, 2021
(86) PCT No.: PCT/JP2021/001457

§ 371 Date: Aug. 23, 2022

(30) Foreign Application Priority Data
Feb. 27, 2020 (JP) 2020-031175

(51) Int. Cl. H02J 13/00; G01D 5/353

(52) U.S. Cl. CPC H02J 13/00; G01D 5/353

(57) ABSTRACT

A power failure detection system according to the present disclosure includes an optical fiber (10) configured to detect a state of a transformer (40), a reception unit (201) configured to receive an optical signal including information indicating the state of the transformer (40), from the optical fiber (10), and a detection unit (202) configured to detect occurrence of a power failure, based on information indicating the state of the transformer (40), the information being included in the optical signal.

### TECHNICAL FIELD

The present disclosure relates to a power failure detection system, a power failure detection device, and a power failure detection method.

### BACKGROUND ART

In a case where a disaster such as an earthquake occurs, various kinds of damage may occur. In addition, in a case where damage occurs, it is necessary to recover to a state before the damage, and therefore, it is necessary to detect whether damage has actually occurred within a range where the disaster has occurred. For example, Patent Literature 1 describes a technique of detecting river levee breach by using an optical fiber as a sensor.

### CITATION LIST

### Patent Literature

[Patent Literature 1] Japanese Unexamined Patent Application Publication No. 2001-249035

### SUMMARY OF INVENTION

### Technical Problem

Incidentally, a power failure may occur due to occurrence of a disaster. When a power failure occurs, lives of people in the neighborhoods are affected, and therefore, it is necessary to perform restoration work promptly. For that purpose, it is required to detect occurrence of a power failure quickly.

Accordingly, an object of the present disclosure is to solve the above-described problem and provide a power failure detection system, a power failure detection device, and a power failure detection method that are capable of quickly detecting occurrence of a power failure.

### Solution to Problem

A power failure detection system according to one aspect includes:

an optical fiber configured to detect a state of a transformer;

a reception unit configured to receive an optical signal including information indicating the state of the transformer from the optical fiber; and

a detection unit configured to detect occurrence of a power failure, based on information indicating the state of the transformer, the information being included in the optical signal.

A power failure detection device according to one aspect includes:

an acquiring unit configured to acquire information indicating a state of a transformer, the information being included in an optical signal received from an optical fiber configured to detect a state of the transformer; and

a detection unit configured to detect occurrence of a power failure, based on information indicating the state of the transformer.

A power failure detection method according to one aspect is a power failure detection method by a power failure detection system, including:

a reception step of receiving an optical signal including information indicating a state of a transformer, from an optical fiber configured to detect the state of the transformer; and

a detection step of detecting occurrence of a power failure, based on information indicating the state of the transformer, the information being included in the optical signal.

### Advantageous Effects of Invention

According to the above-described aspects, it is possible to acquire an effect of providing a power failure detection system, a power failure detection device, and a power failure detection method that are capable of detecting occurrence of a power failure quickly.

### BRIEF DESCRIPTION OF DRAWINGS

FIG. 1 is a diagram illustrating a configuration example of a power failure detection system according to a first example embodiment;

FIG. 2 is a diagram illustrating an example of information indicating a state of vibration of a transformer;

FIG. 3 is a flowchart illustrating an operation example of a power failure detection system according to the first example embodiment;

FIG. 4 is a diagram illustrating an example of transformer information held by a detection unit according to a second example embodiment;

FIG. 5 is a flowchart illustrating an operation example of a power failure detection system according to the second example embodiment;

FIG. 6 is a diagram illustrating an example configuration of a power failure detection system according to the third example embodiment;

FIG. 7 is a diagram illustrating an example of a prior condition in a case where a report unit according to the third example embodiment causes a display unit to display a GUI screen;

FIG. 8 is a diagram illustrating an example of a GUI screen which the report unit according to the third example embodiment causes to be displayed on the display unit;

FIG. 9 is a diagram illustrating an example of a GUI screen which the report unit according to the third example embodiment causes to be displayed on the display unit;

FIG. 10 is a diagram illustrating an example of a GUI screen which the report unit according to the third example embodiment causes to be displayed on the display unit;

FIG. 11 is a flowchart illustrating an operation example of the power failure detection system according to the third example embodiment;

FIG. 12 is a diagram illustrating a configuration example of a power failure detection system according to another example embodiment;

FIG. 13 is a diagram illustrating a configuration example of a power failure detection system according to another example embodiment;

FIG. 14 is a diagram illustrating a configuration example of a power failure detection system according to another example embodiment; and

FIG. 15 is a block diagram illustrating an example of a hardware configuration of a computer that achieves power failure detection device according to the example embodiments.

### EXAMPLE EMBODIMENT

Hereinafter, example embodiments of the present disclosure are explained with reference to the drawings. Note that the following explanation and drawings are abbreviated and simplified as appropriate for the clarity of explanation. Furthermore, in each of the following drawings, the same elements are designated with the same reference numerals, and duplicate explanations are omitted as necessary.

### First Example Embodiment

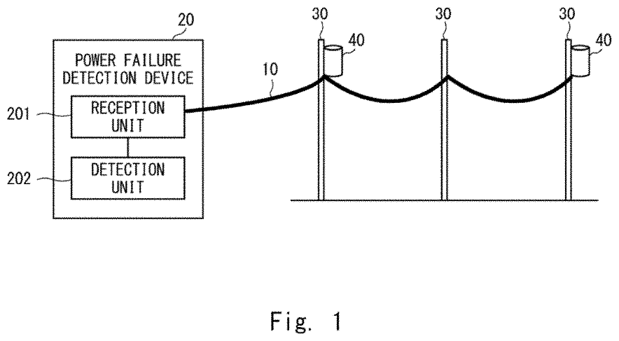

First, a configuration example of a power failure detection system according to a first example embodiment is explained with reference to FIG. 1.

As illustrated in FIG. 1, a power failure detection system according to this first example embodiment includes an optical fiber 10 and a power failure detection device 20. Furthermore, the power failure detection device 20 includes a reception unit 201 and a detection unit 202.

The optical fiber 10 is provided on multiple utility poles 30 (three utility poles 30 in FIG. 1), and one end is connected to the power failure detection device 20. The optical fiber 10 may be an optical fiber dedicated to sensing, or an optical fiber for both communication and sensing. When the optical fiber 10 is an optical fiber for both communication and sensing, an optical signal for sensing is demultiplexed by a filter (not illustrated) on a stage prior to the reception unit 201, so that the reception unit 201 can receive only the optical signal for sensing. Although only one optical fiber 10 is provided in FIG. 1, multiple optical fibers 10 may be provided as explained later.

The reception unit 201 receives the optical signal (the optical signal for sensing; the same applies to the following explanation) from the optical fiber 10. For example, the reception unit 201 injects pulsed light into the optical fiber 10, and also receives the back scattered light, which is generated in response to transmission of the pulsed light through the optical fiber 10, as an optical signal.

In this case, some utility poles 30 are equipped with transformers 40 that transform electric power supplied from a power plant or the like (not illustrated) and supply the transformed electric power to homes, factories, and the like.

The states of the transformers 40 change at the time of a power failure. For example, when power is normally supplied to the transformer 40 from the power plant or the like, the transformer 40 is always in operation. The transformer 40 in operation generates vibration and operating sound, and the temperature rises. Conversely, when a power failure occurs, the power supply from the power plant or the like to the transformer 40 stops, and accordingly, the transformer 40 stops the operation. The transformer 40, which has stopped the operation, does not generate vibrations and operating sound, and the temperature drops.

In a situation where the transformer 40 is provided in the vicinity of the optical fiber 10, when the state of the transformer 40 changes, the characteristics (for example, a wavelength) of the optical signal transmitted through the optical fiber 10 change according to the change in the state of the transformer 40. Therefore, the optical fiber 10 can detect the state of the transformer 40, and the optical signal received by the reception unit 201 includes information indicating the state of the transformer 40 detected by the optical fiber 10. The information indicating the state of the transformer 40 may be any information indicating at least one of the state of vibration of the transformer 40, the state of operating sound of the transformer 40, and the state of the temperature of the transformer 40.

Therefore, the detection unit 202 can detect occurrence of a power failure by analyzing the information indicating the state of the transformer 40 included in the optical signal received by the reception unit 201.

Hereinafter, an example of a method for detecting occurrence of a power failure in the detection unit 202 is explained.

First, the detection unit 202 identifies the operating state of the transformer 40 on the basis of the information indicating the state of the transformer 40 included in the optical signal received by the reception unit 201.

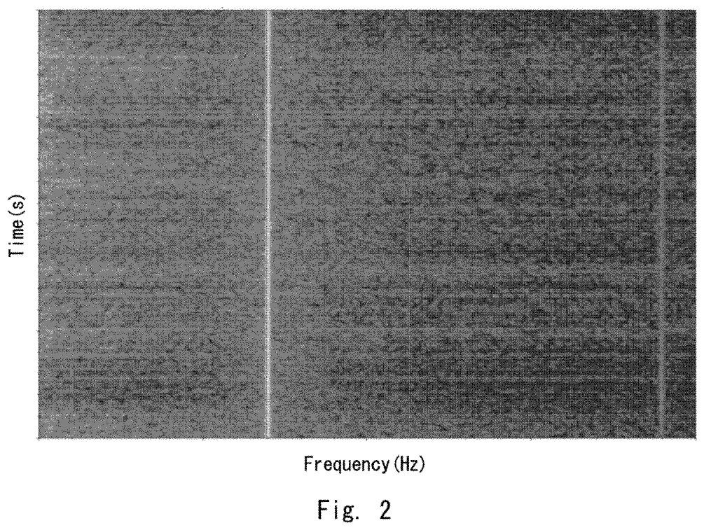

FIG. 2 illustrates an example of information illustrating the state of vibration of the transformer 40. FIG. 2 illustrates an example of vibration characteristics of the optical signal of the optical fiber 10 generated in the vicinity of the transformer 40 when the transformer 40 is operating normally. The horizontal axis indicates the frequency, and the vertical axis indicates the time. As illustrated in FIG. 2, when the transformer 40 is operating normally, constant vibration occurs at a specific frequency. Therefore, for example, when constant vibration is generated at a specific frequency, the detection unit 202 determines that the transformer 40 is operating, and in other cases, the detection unit 202 determines that the transformer 40 is not operating.

The detection unit 202 may identify the operating state of the transformer 40 on the basis of information indicating the state of the operating sound of the transformer 40 or the state of temperature of the transformer 40 included in the optical signal received by the reception unit 201. For example, the detection unit 202 determines that the transformer 40 is operating when the transformer 40 is making an operating sound, and in other cases, the detection unit 202 determines that the transformer 40 is not operating. Furthermore, when the temperature of the transformer 40 is equal to or higher than a threshold value, the detection unit 202 determines that the transformer 40 is operating, and in other cases, the detection unit 202 determines that the transformer 40 is not operating.

Then, the detection unit 202 detects occurrence of a power failure on the basis of the operating state of the transformer 40. For example, when the transformer 40 is operating, the detection unit 202 determines that a power failure has not occurred, and when the transformer 40 has stopped the operation, the detection unit 202 determines that a power failure has occurred.

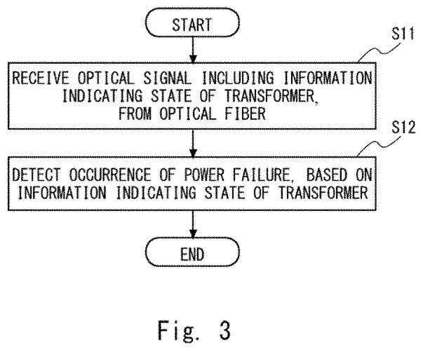

Next, an example of an operation flow of the power failure detection system according to this first example embodiment is explained with reference to FIG. 3.

As illustrated in FIG. 3, the reception unit 201 receives, from the optical fiber 10, an optical signal including information indicating the state of the transformer 40 detected by the optical fiber 10 (step S11).

Subsequently, the detection unit 202 detects occurrence of a power failure on the basis of the information indicating the state of the transformer 40 included in the optical signal received by the reception unit 201 (step S12). For example, as described above, the detection unit 202 may first identify the operating state of the transformer 40 on the basis of the information indicating the state of the transformer 40, and detect occurrence of a power failure on the basis of the operating state of the transformer 40.

As described above, according to this first example embodiment, the reception unit 201 receives, from the optical fiber 10, the optical signal including the information indicating the state of the transformer 40 detected by the optical fiber 10. The detection unit 202 detects occurrence of a power failure on the basis of the information included in the optical signal indicating the state of the transformer 40. In this way, occurrence of a power failure can be detected remotely and in real time on the basis of the information indicating the state of the transformer 40 included in the optical signal. Therefore, occurrence of a power failure can be detected at an early stage.

### Second Example Embodiment

The power failure detection system according to this second example embodiment has substantially the same configuration as the configuration of the first example embodiment described above, but has expanded the functions of the detection unit 202. Specifically, the detection unit 202 has such a function that, when the detection unit 202 determines that a power failure has occurred, the detection unit 202 identifies a power failure occurrence position, which is a position where a power failure occurred, and a power failure occurrence area, which is an area where the power failure has occurred.

Hereinafter, an example of a method of identifying a power failure occurrence position and a power failure occurrence area with the detection unit 202 is explained.

The detection unit 202 can identify the position where the optical signal is generated (i.e., a distance in the optical fiber 10 from the power failure detection device 20) on the basis of the optical signal received by the reception unit 201. For example, the detection unit 202 can identify the position where the optical signal is generated on the basis of the time difference between the time when the reception unit 201 injects pulsed light to the optical fiber 10 and the time when the optical signal is received. Alternatively, the detection unit 202 can identify the position where the optical signal is generated on the basis of the reception strength of the optical signal received by the reception unit 201. For example, the detection unit 202 identifies that the position where the optical signal is generated is farther from the power failure detection device 20 as the reception intensity of the optical signal decreases.

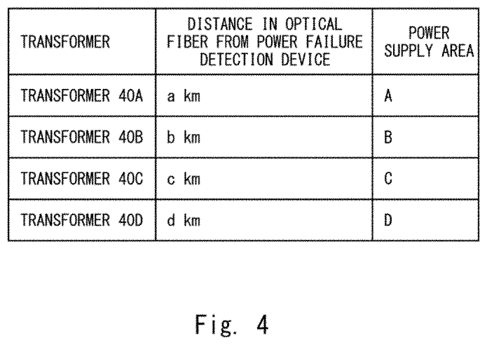

In addition, the detection unit 202 previously stores, for each of the transformers 40 provided in the vicinity of the optical fiber 10, transformer information indicating the installation position of the transformer 40 in question (i.e., a distance in the optical fiber 10 from the power failure detection device 20) and a power supply area indicating an area that receives power from the transformer 40 in question. FIG. 4 illustrates an example of transformer information held by the detection unit 202. FIG. 4 is an example in the case where four transformers 40A to 40D are provided in the vicinity of the optical fiber 10.

For example, it is assumed that the detection unit 202 determines that the transformer 40 has stopped the operation and a power failure has occurred on the basis of the information indicating the state of the transformer 40 included in the optical signal received by the reception unit 201.

In this case, the detection unit 202 first identifies the position where the optical signal is generated (i.e., a distance in the optical fiber 10 from the power failure detection device 20) on the basis of the optical signal received by the reception unit 201.

Subsequently, the detection unit 202 identifies the transformer 40 that has stopped the operation and the installation position of the transformer 40 by referring to the transformer information in FIG. 4 using the position where the optical signal is generated as a key. Then, the detection unit 202 identifies the installation position of the transformer 40, which has stopped the operation, as a power failure occurrence position.

Furthermore, the detection unit 202 identifies the power supply area of the transformer 40 by referring to the transformer information in FIG. 4 using the transformer 40 that has been stopped the operation as a key, and identifies the power supply area of the transformer 40 as a power failure occurrence area.

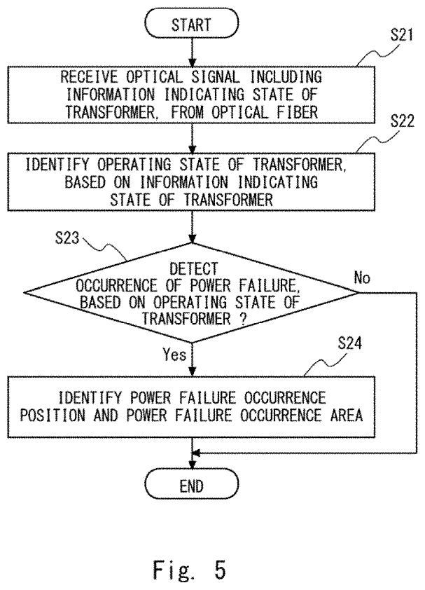

Subsequently, an example of a flow of an operation of the power failure detection system according to this second example embodiment is explained with reference to FIG. 5.

As illustrated in FIG. 5, the reception unit 201 receives, from the optical fiber 10, an optical signal including information indicating the state of the transformer 40 detected by the optical fiber 10 (step S21).

Subsequently, the detection unit 202 identifies the operating state of the transformer 40 on the basis of the information included in the optical signal received by the reception unit 201, which indicates the state of the transformer 40 (step S22).

Subsequently, the detection unit 202 detects occurrence of a power failure on the basis of the operating state of the transformer 40 (step S23). For example, when the transformer 40 is not operating, the detection unit 202 determines that a power failure has occurred.

In a case where the detection unit 202 determines that a power failure has occurred in step S23 (Yes in step S23), subsequently, the detection unit 202 identifies the transformer 40 that has stopped the operation and the installation position of the transformer 40 on the basis of the optical signal received by the reception unit 201, and identifies the installation position of the transformer 40 as the power failure occurrence position. Furthermore, the detection unit 202 identifies the power supply area of the transformer 40 that has stopped the operation, and identifies the power supply area of the transformer 40 as the power failure occurrence area (step S24).

As described above, according to this second example embodiment, in the case where the detection unit 202 determines that a power failure has occurred, the detection unit 202 identifies the power failure occurrence position and the power failure occurrence area. Accordingly, not only occurrence of a power failure can be detected, but also the power failure occurrence position and the power failure occurrence area where the power failure has occurred can be identified.

Other effects are similar to those of the first example embodiment described above.

### Third Example Embodiment

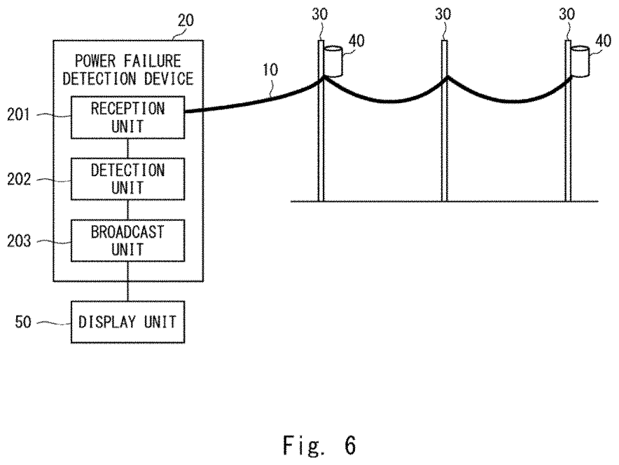

Subsequently, a configuration example of a power failure detection system according to this third example embodiment is explained with reference to FIG. 6.

As illustrated in FIG. 6, as compared with the above-described first and second example embodiments, the power failure detection system according to this third example embodiment is different in that a display unit 50 is added, and a report unit 203 is added to the inside of the power failure detection device 20.

The display unit 50 is provided in a communication station building, an operation center, and the like, and is a display, a monitor, and the like for displaying various kinds of information.

The report unit 203 previously stores information indicating the installation position of the optical fiber 10, information indicating the installation position and the power supply area of the transformer 40, and map information such that they are associated with each other. Then, in a case where the detection unit 202 determines that a power failure has occurred, the report unit 203 causes the display unit 50 to display a GUI (Graphical User Interface) screen in which information of at least one of the power failure occurrence position and the power failure occurrence area identified by the detection unit 202 is superimposed on the map information.

Hereinafter, an example of a GUI screen displayed on the display unit 50 with the report unit 203 is explained. Note that the map on the GUI screen described below can be enlarged and reduced as needed.

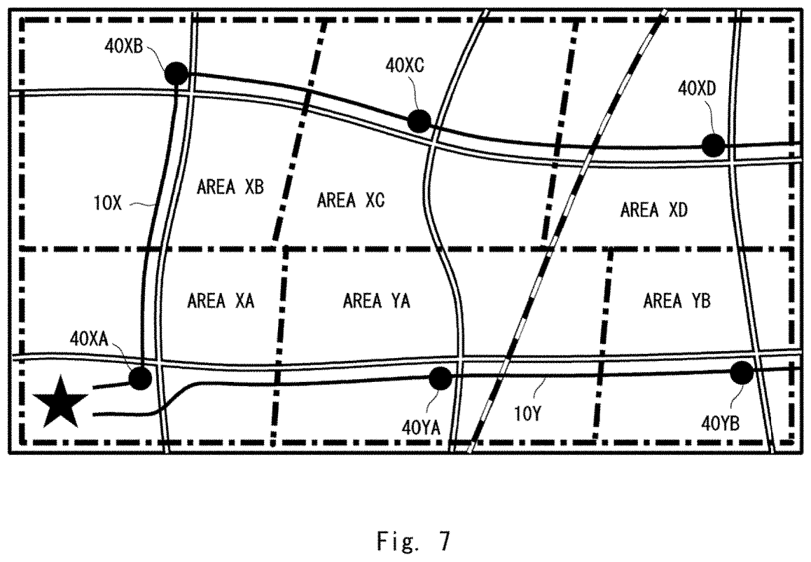

First, the prior condition when displaying the GUI screen described below is explained with reference to FIG. 7.

In the following explanation, it is assumed that as illustrated in FIG. 7 and two optical fibers 10X and 10Y are provided. It is assumed that the power failure detection device 20 is provided at the position of a star mark at the lower left of FIG. 7 and two optical fibers 10X and 10Y are connected. Further, it is assumed that transformers 40XA to 40XD are provided in the vicinity of the optical fiber 10X, and the power supply areas of the transformers 40XA to 40XD are the power supply areas XA to XD, respectively. It is assumed that transformers 40YA and 40YB are provided in the vicinity of the optical fiber 10Y, and the power supply areas of the transformers 40YA and 40YB are the power supply areas YA and YB, respectively. In addition, the detection unit 202 holds the transformer information (see FIG. 4) of the transformers 40XA to 40XD in the vicinity of the optical fiber 10X. By analyzing the information indicating the state of the transformers 40XA to 40XD included in the optical signal received from the optical fiber 10X, the occurrence of a power failure in the vicinity of the optical fiber 10X is detected, and the power failure occurrence position and the power failure occurrence area are identified. The same applies to optical fiber 10Y.

In the following explanation, the transformers 40XC and 40XD have stopped the operation, and accordingly, it is assumed that the detection unit 202 identifies the power failure occurrence positions as the installation positions of transformers 40XC and 40XD, and identifies the power failure occurrence areas as the power supply areas XC, XD of the transformers 40XC and 40XD.

### (1) First Example

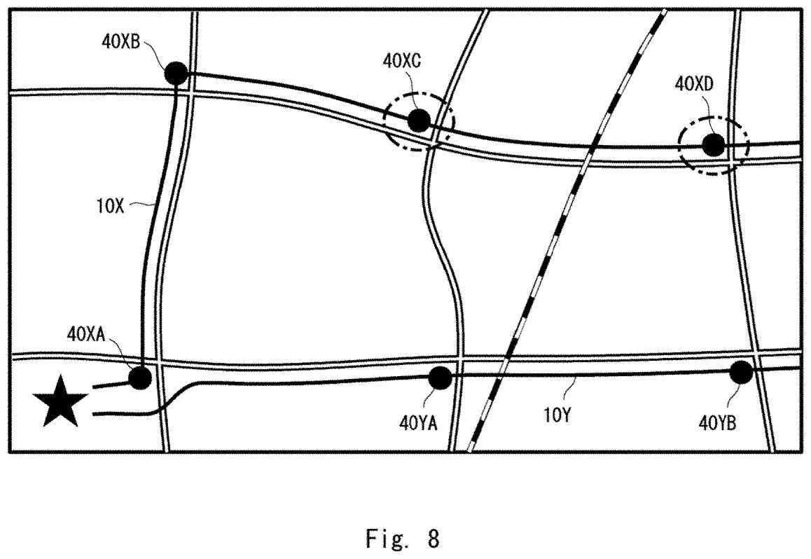

As illustrated in FIG. 8, the GUI screen according to this example is a screen in which, on the map, the installation positions of the optical fibers 10X, 10Y and the installation positions of the transformers 40XA to 40XD, 40YA, and 40YB are superimposed, and the power failure occurrence positions (the installation positions of the transformer 40XC, 40XD) are superimposed. In FIG. 8, the power failure occurrence positions are indicated as circles including the power failure occurrence positions on the map.

### (2) Second Example

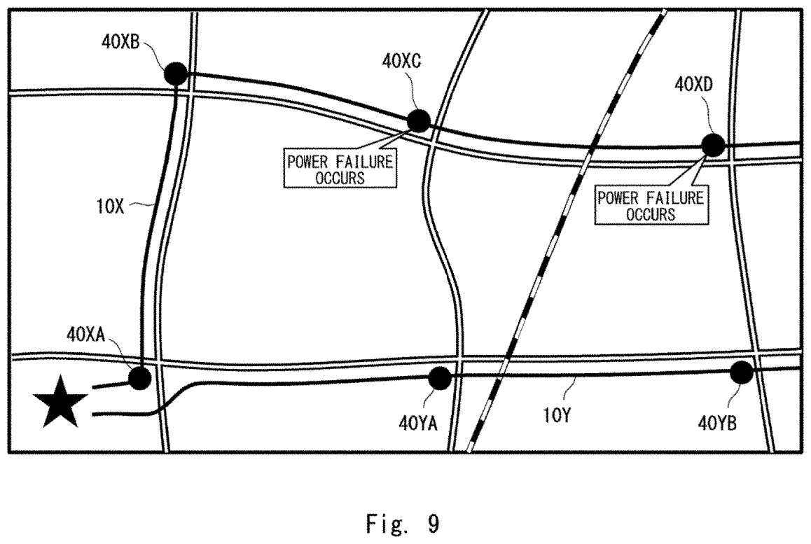

As illustrated in FIG. 9, the GUI screen according to this example is a screen in which, on the map, the installation positions of the optical fibers 10X, 10Y and the installation positions of the transformers 40XA to 40XD, 40YA, and 40YB are superimposed, and the power failure occurrence positions (the installation positions of the transformers 40XC, 40XD) are superimposed. In FIG. 9, the power failure occurrence positions are indicated with balloons on the map.

### (3) Third Example

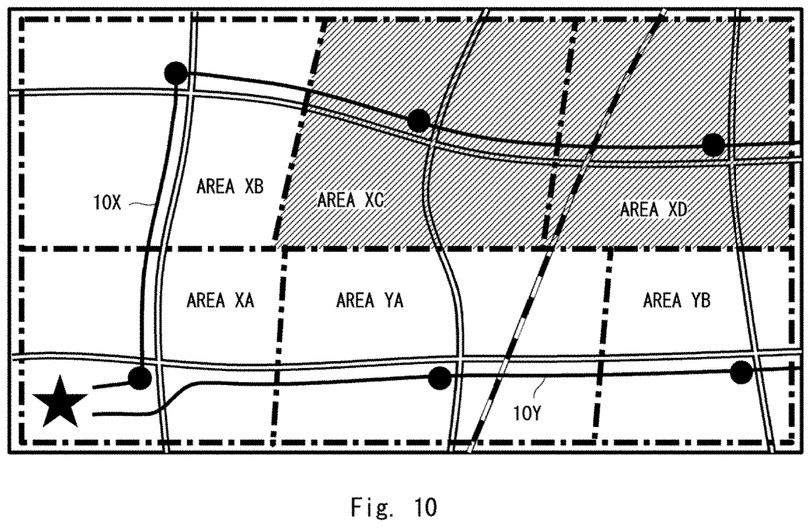

As illustrated in FIG. 10, the GUI screen according to this example is a screen in which, on the map, the installation positions of the optical fibers 10X, 10Y, the installation positions of the transformers 40XA to 40XD, 40YA, and 40YB, and the positions of the power supply areas XA to XD, YA, and YB are superimposed, and the power failure occurrence area (the power supply areas XC, XD) are superimposed. In FIG. 10, the power failure occurrence areas are indicated as being emphasized by diagonal lines on the map.

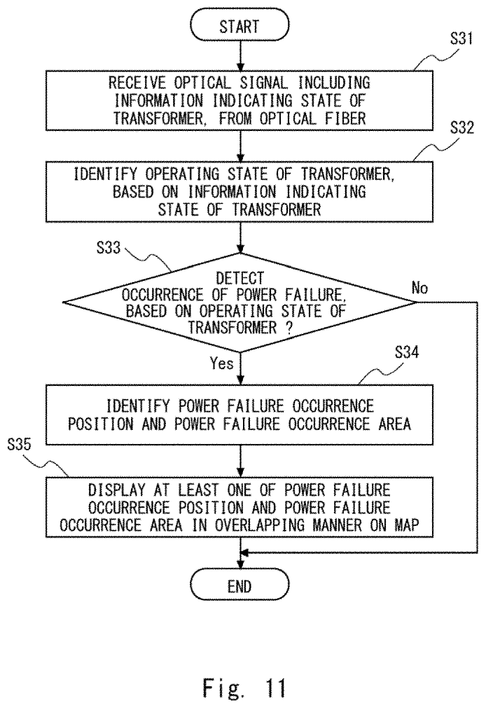

Subsequently, an example of a flow of an operation of the power failure detection system according to this third example embodiment is explained with reference to FIG. 11.

As illustrated in FIG. 11, first, steps S31 to S34 similar to steps S21 to S24 of FIG. 5 are performed.

Subsequently, the report unit 203 causes the display unit 50 to display at least one of the power failure occurrence position and the power failure occurrence area identified by the detection unit 202 by superimposing the at least one of the power failure occurrence position and the power failure occurrence area on the map (step S35). For example, this display may be performed with the GUI screen illustrated in FIG. 8 to FIG. 10.

According to the above-described third example embodiment, in a case where the detection unit 202 determines that a power failure has occurred, the report unit 203 causes the display unit 50 to display at least one of the power failure occurrence position and the power failure occurrence area identified by the detection unit 202 is superimposed on the map by superimposing the at least one of the power failure occurrence position and the power failure occurrence area on the map. Therefore, the at least one of the power failure occurrence position and the power failure occurrence area can be notified to a communication station building, an operation center, and the like, in which the display unit 50 is provided.

Other effects are similar to those of the second example embodiment described above.

The report unit 203 does not have to only cause the display unit 50 to display the power failure occurrence positions and the power failure occurrence areas, and may notify information about the power failure occurrence positions and the power failure occurrence areas by telephone, e-mail, or the like to a communication station building, an operation center, and the like.

### Other Example Embodiments

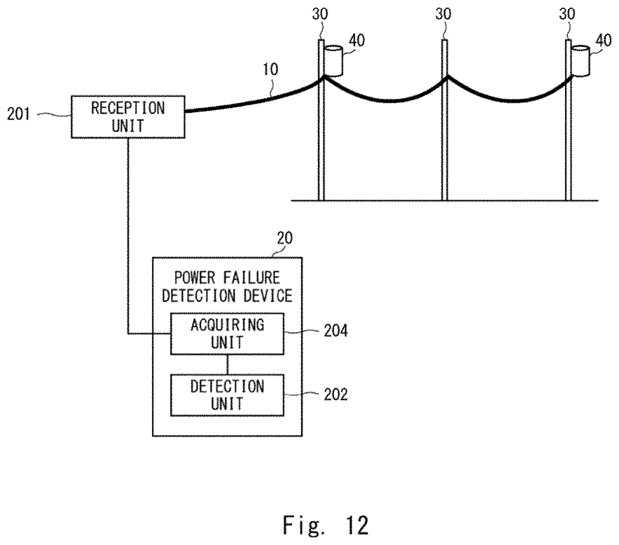

In the above-described example embodiments, the reception unit 201 is provided in the power failure detection device 20, but the present invention is not limited thereto. The reception unit 201 may be provided outside the power failure detection device 20. FIG. 12 illustrates a configuration example of a power failure detection system in which the reception unit 201 is provided outside the power failure detection device 20. In the example of FIG. 12, the power failure detection device 20 is provided with an acquiring unit 204 instead of the reception unit 201. The acquiring unit 204 acquires information indicating the state of the transformer 40, included in the optical signal received from the optical fiber 10 by the reception unit 201. In the example of FIG. 12, the power failure detection device 20 may be provided at a position away from the optical fiber 10, and for example, it may be provided on the cloud. With respect to the power failure detection system illustrated in FIG. 12, the display unit 50 may be added and the report unit 203 may be added to the power failure detection device 20 as in the third example embodiment described above.

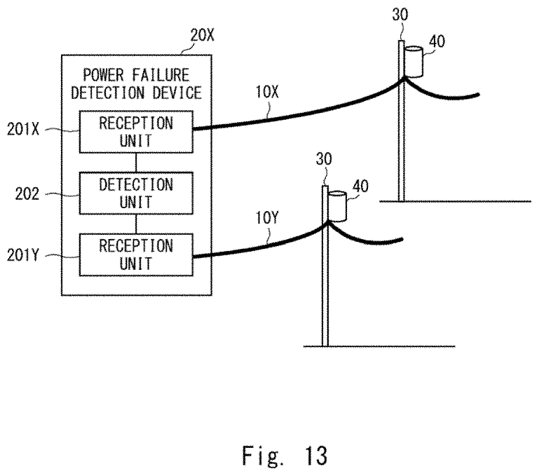

Furthermore, in the above-described example embodiments, only one reception unit 201 is provided, but the present invention is not limited thereto. For example, as illustrated in FIG. 7 to FIG. 10, multiple optical fibers 10 may be provided. In this case, multiple reception units 201 may be provided to correspond to the multiple optical fibers 10. FIG. 13 illustrates an example of a power failure detection system in which two reception units 201X and 201Y are provided to correspond to two optical fibers 10X and 10Y, respectively. In the example of FIG. 13, two reception units 201X and 201Y are provided in the power failure detection device 20. The detection unit 202 detects occurrence of a power failure in the vicinity of optical fiber 10X, using the method described in the second example embodiment with the optical signal received by the reception unit 201X from the optical fiber 10X, and identifies the power failure occurrence position and the power failure occurrence area. Also, the same applies to the optical fiber 10Y. With respect to the power failure detection system illustrated in FIG. 13, the display unit 50 may be added and the report unit 203 may be added to the power failure detection device 20 as in the third example embodiment described above. Furthermore, in the power failure detection system illustrated in FIG. 13, two reception units 201X and 201Y may be provided outside the power failure detection device 20 as illustrated in FIG. 12 described above.

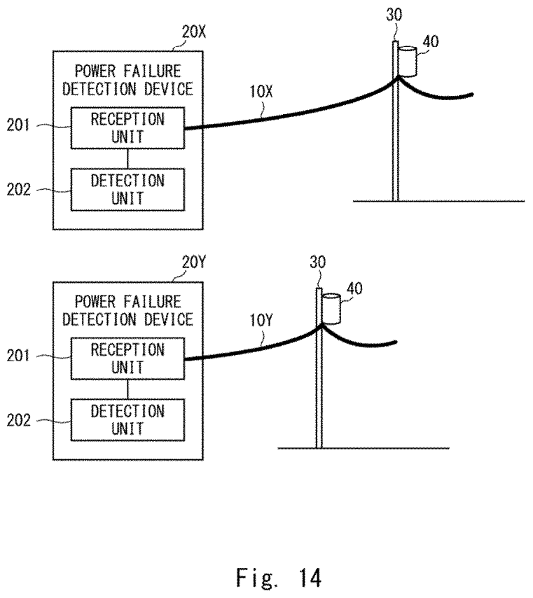

Furthermore, although only one power failure detection device 20 is provided in the above-described example embodiment, the present invention is not limited thereto. For example, multiple power failure detection devices 20 may be provided to correspond to the multiple optical fibers 10. FIG. 14 illustrates an example of a power failure detection system in which two power failure detection devices 20X and 20Y are provided to correspond to two optical fibers 10X and 10Y, respectively. In the example of FIG. 14, in the power failure detection device 20X, occurrence of a power failure in the vicinity of optical fiber 10X is detected using the method described in the second example embodiment with the optical signal received from the optical fiber 10X, and the power failure occurrence position and the power failure occurrence area are identified. Furthermore, in the power failure detection device 20Y, occurrence of a power failure in the vicinity of optical fiber 10Y is detected using the method described in the second example embodiment with the optical signal received from the optical fiber 10Y, and the power failure occurrence position and the power failure occurrence area are identified. With respect to the power failure detection system illustrated in FIG. 14, the display unit 50 may be added and the report unit 203 may be added to each of the power failure detection devices 20X, 20Y as in the third example embodiment described above. In this case, the display unit 50 may be shared by the two power failure detection devices 20X, 20Y, or a separate display unit 50 may be individually provided for each of the two power failure detection devices 20X, 20Y. Furthermore, in the power failure detection system illustrated in FIG. 14, the reception unit 201 in each of the power failure detection devices 20X, 20Y may be provided outside the power failure detection devices 20X, 20Y as in FIG. 12 described above.

Furthermore, although the detection unit 202 detects occurrence of a power failure in the above-described example embodiment, a sign of a power failure may be detected in addition. For example, before a power failure occurs, power supply from the power plant to the transformer 40 becomes unstable, and it is considered that the transformer 40 may cause an abnormal temperature or abnormal operating sound. Therefore, the detection unit 202 may determine that there is a sign of a power failure when the detection unit 202 detects that the transformer 40 has an abnormal temperature or an abnormal operating sound on the basis of the information indicating the state of the transformer 40. In the case where the detection unit 202 determines that there is a sign of a power failure, the detection unit 202 may identify the installation position of the transformer 40 and the power supply area, in which an abnormal temperature and the like occur, as the positions and areas where there is a sign of a power failure. Furthermore, the report unit 203 may cause the display unit 50 to display at least one of the position and the area where there is a sign of a power failure on the map by superimposing the at least one of the position and the area on the map.

Furthermore, although the optical fiber 10 is provided on the utility pole 30 in the above-described example embodiment, the present invention is not limited thereto. As described above, the optical fiber 10 plays a role of detecting the state of the transformer 40. Therefore, the optical fiber 10 may be provided in any manner as long as it is provided in the vicinity of the transformer 40. For example, when the transformer 40 is buried in the ground, the optical fiber 10 may also be buried in the ground. When the optical fiber 10 is installed, the density of the optical fiber 10 around the transformer 40 may be increased by winding the optical fiber 10 around the transformer 40. As a result, it is possible to improve the detection accuracy of the optical fiber 10 for detecting the state of the transformer 40.

### <Hardware Configuration of Power Failure Detection Device According to Example Embodiment>

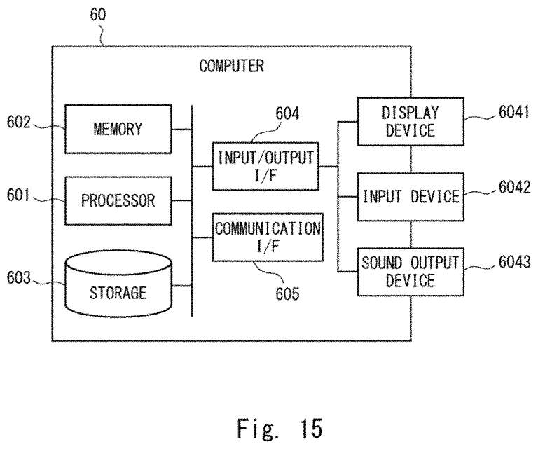

Next, hereinafter, a hardware configuration of a computer 60 that achieves the power failure detection devices 20, 20X, and 20Y is explained with reference to FIG. 15.

As illustrated in FIG. 15, the computer 60 includes a processor 601, a memory 602, a storage 603, an input/output interface (an input/output I/F) 604, a communication interface (a communication I/F) 605, and the like. The processor 601, the memory 602, the storage 603, the input/output interface 604, and the communication interface 605 are connected through a data transmission line for transmitting and receiving data to and from one another.

The processor 601 is, for example, an arithmetic processing unit such as a Central Processing Unit (CPU) and a Graphics Processing Unit (GPU). The memory 602 is, for example, a memory such as a Random Access Memory (RAM) and a Read Only Memory (ROM). The storage 603 is, for example, a storage device such as a Hard Disk Drive (HDD), a Solid State Drive (SSD), and a memory card. Alternatively, the storage 603 may be a memory such as a RAM and a ROM.

The storage 603 stores programs that realize the functions of the components provided in the power failure detection devices 20, 20X, and 20Y. The processor 601 achieves the functions of the components provided in the power failure detection device 20 by executing these programs. In this case, when executing each of the above programs, the processor 601 may load the program on the memory 602 and then execute the program, or may execute the program without loading the program on the memory 602. In addition, the memory 602 and the storage 603 are also configured to store information and data held by the components provided in the power failure detection device 20.

The above-described programs are stored using any of various types of non-transitory computer readable media and can be supplied to a computer (including the computer 60). The non-transitory computer readable media include various types of tangible storage media. Examples of the non-transitory computer readable media include magnetic recording media (for example, flexible discs, magnetic tapes, hard disk drives), magneto-optical recording media (for example, magneto-optical discs), Compact Disc-ROMs (CD-ROMs), CD-Recordables (CD-Rs), CD-ReWritables (CD-R/Ws), semiconductor memories (for example, mask ROMs, Programmable ROMs (PROMs), Erasable PROMs (EPROMs), flash ROMs, and RAMs. The programs may also be supplied to a computer through any of various types of transitory computer readable media. Examples of the transitory computer readable media include electrical, optical signals, and electromagnetic waves. The transitory computer readable media can supply the programs to the computer via a wired communication path, such as an electric wire and an optical fiber, or a wireless communication path.

The input/output interface 604 is connected to a display device 6041, an input device 6042, a sound output device 6043, and the like. The display device 6041 is a device that displays a screen corresponding to drawing data processed by the processor 601, such as a Liquid Crystal Display (LCD), a Cathode Ray Tube (CRT) display, and a monitor. The input device 6042 is a device that receives an operator's operation input, and is, for example, a keyboard, a mouse, a touch sensor, or the like. The display device 6041 and the input device 6042 may be integrated and realized as a touch panel. The sound output device 6043 is a device, such as a speaker, that acoustically outputs sound corresponding to acoustic data processed by the processor 601.

The communication interface 605 transmits/receives data to/from an external device. For example, the communication interface 605 communicates with an external device via a wired communication path or a wireless communication path.

Although the present disclosure has been described above with reference to the example embodiments, the present disclosure is not limited to the above-described example embodiments. Various changes that can be understood by those skilled in the art can be made to the structure and details of the present disclosure within the scope of the present disclosure.

For example, some or all of the above-described example embodiments may be used in combination.

In addition, the whole or part of the example embodiments disclosed above can be described as, but not limited to, the following supplementary notes.

(Supplementary Note 1)

A power failure detection system comprising:

an optical fiber configured to detect a state of a transformer;

a reception unit configured to receive an optical signal including information indicating the state of the transformer, from the optical fiber; and

a detection unit configured to detect occurrence of a power failure, based on information indicating the state of the transformer, the information being included in the optical signal.

(Supplementary Note 2)

The power failure detection system according to Supplementary Note 1, wherein the detection unit identifies an operating state of the transformer, based on information indicating the state of the transformer, and in a case where the transformer has stopped operation, the detection unit determines that a power failure has occurred.

(Supplementary Note 3)

The power failure detection system according to Supplementary Note 2, wherein, in a case where the detection unit determines that a power failure has occurred, the detection unit identifies the transformer that has stopped operation and an installation position of the transformer, based on the optical signal, and identifies the installation position of the transformer as a position where the power failure has occurred.

(Supplementary Note 4)

The power failure detection system according to Supplementary Note 3, wherein, in a case where the detection unit determines that a power failure has occurred, the detection unit identifies an area that receives power supply from the transformer that has stopped operation, and identifies the area that receives power supply from the transformer as an area where the power failure has occurred.

(Supplementary Note 5)

The power failure detection system according to Supplementary Note 4, further comprising:

a display unit; and

a report unit configured to, in a case where the detection unit determines that a power failure has occurred, cause the display unit to display at least one of a position and an area where the power failure has occurred in an overlapping manner on a map.

(Supplementary Note 6)

The power failure detection system according to any one of Supplementary Notes 1 to 5, wherein the information indicating the state of the transformer is information indicating at least one of a state of vibration of the transformer, a state of an operating sound of the transformer, and a state of a temperature of the transformer.

(Supplementary Note 7)

A power failure detection device comprising:

an acquiring unit configured to acquire information indicating a state of a transformer, the information being included in an optical signal received from an optical fiber configured to detect the state of the transformer; and

a detection unit configured to detect occurrence of a power failure, based on information indicating the state of the transformer.

(Supplementary Note 8)

The power failure detection device according to Supplementary Note 7, wherein the detection unit identifies an operating state of the transformer, based on information indicating the state of the transformer, and in a case where the transformer has stopped operation, the detection unit determines that a power failure has occurred.

(Supplementary Note 9)

The power failure detection device according to Supplementary Note 8, wherein, in a case where the detection unit determines that a power failure has occurred, the detection unit identifies the transformer that has stopped operation and an installation position of the transformer, based on the optical signal, and identifies the installation position of the transformer as a position where the power failure has occurred.

(Supplementary Note 10)

The power failure detection device according to Supplementary Note 9, wherein, in a case where the detection unit determines that a power failure has occurred, the detection unit identifies an area that receives power supply from the transformer that has stopped operation, and identifies the area that receives the power supply from the transformer as an area where the power failure has occurred.

(Supplementary Note 11)

The power failure detection device according to Supplementary Note 10, further comprising a report unit configured to, in a case where the detection unit determines that a power failure has occurred, cause a display unit to display at least one of a position and an area where the power failure has occurred in an overlapping manner on a map.

(Supplementary Note 12)

The power failure detection device according to any one of Supplementary Notes 7 to 11, wherein the information indicating the state of the transformer is information indicating at least one of a state of vibration of the transformer, a state of an operating sound of the transformer, and a state of a temperature of the transformer.

(Supplementary Note 13)

A power failure detection method by a power failure detection system, the method comprising:

a reception step of receiving an optical signal including information indicating a state of a transformer, from an optical fiber configured to detect the state of the transformer; and

a detection step of detecting occurrence of a power failure, based on information indicating the state of the transformer, the information being included in the optical signal.

(Supplementary Note 14)

The power failure detection method according to Supplementary Note 13, wherein the detection step further includes identifying an operating state of the transformer, based on information indicating the state of the transformer, and in a case where the transformer has stopped operation, determining that a power failure has occurred.

(Supplementary Note 15)

The power failure detection method according to Supplementary Note 14, wherein the detection step further includes, in a case of determining that a power failure has occurred, identifying the transformer that has stopped operation and an installation position of the transformer, based on the optical signal, and identifying the installation position of the transformer as a position where the power failure has occurred.

(Supplementary Note 16)

The power failure detection method according to Supplementary Note 15, wherein the detection step further includes, in a case of determining that a power failure has occurred, identifying an area that receives power supply from the transformer that has stopped operation, and identifying the area that receives power supply from the transformer as an area where the power failure has occurred.

(Supplementary Note 17)

The power failure detection method according to Supplementary Note 16, further comprising a report step of, in a case of determining that a power failure has occurred in the detection step, causing a display unit to display at least one of a position and an area where the power failure has occurred in an overlapping manner on a map.

(Supplementary Note 18)

The power failure detection method according to any one of Supplementary Notes 13 to 17, wherein the information indicating the state of the transformer is information indicating at least one of a state of vibration of the transformer, a state of an operating sound of the transformer, and a state of a temperature of the transformer.

The present application claims the benefit of priority to Japanese Patent Application No. 2020-031175 filed on Feb. 27, 2020, the entire content of which is incorporated herein by reference.

### REFERENCE SIGNS LIST

10, 10X, 10Y OPTICAL FIBER
20, 20X, 20Y POWER FAILURE DETECTION DEVICE
201, 201X, 201Y RECEPTION UNIT
202 DETECTION UNIT
203 REPORT UNIT
204 ACQUIRING UNIT
30 UTILITY POLE
40, 40XA to 40XD, 40YA, 40YB TRANSFORMER
50 DISPLAY UNIT
60 COMPUTER
601 PROCESSOR
602 MEMORY
603 STORAGE
604 INPUT/OUTPUT INTERFACE
6041 DISPLAY DEVICE
6042 INPUT DEVICE
6043 SOUND OUTPUT DEVICE
605 COMMUNICATION INTERFACE
XA to XD, YA, YB POWER SUPPLY AREA

What is claimed is:

1. A power failure detection system comprising:
an optical fiber configured to detect a state of a transformer;
a reception unit configured to receive an optical signal including information indicating the state of the transformer, from the optical fiber; and
a detection unit configured to detect occurrence of a power failure, based on information indicating the state of the transformer, the information being included in the optical signal.

2. The power failure detection system according to claim 1, wherein the detection unit identifies an operating state of the transformer, based on information indicating the state of the transformer, and in a case where the transformer has stopped operation, the detection unit determines that a power failure has occurred.

3. The power failure detection system according to claim 2, wherein, in a case where the detection unit determines that a power failure has occurred, the detection unit identifies the transformer that has stopped operation and an installation position of the transformer, based on the optical signal, and identifies the installation position of the transformer as a position where the power failure has occurred.

4. The power failure detection system according to claim 3, wherein, in a case where the detection unit determines that a power failure has occurred, the detection unit identifies an area that receives power supply from the transformer that has stopped operation, and identifies the area that receives power supply from the transformer as an area where the power failure has occurred.

5. The power failure detection system according to claim 4, further comprising:
a display unit; and
a report unit configured to, in a case where the detection unit determines that a power failure has occurred, cause the display unit to display at least one of a position and an area where the power failure has occurred in an overlapping manner on a map.

6. The power failure detection system according to claim 1, wherein the information indicating the state of the transformer is information indicating at least one of a state of vibration of the transformer, a state of an operating sound of the transformer, and a state of a temperature of the transformer.

7. A power failure detection device comprising:
an acquiring unit configured to acquire information indicating a state of a transformer, the information being included in an optical signal received from an optical fiber configured to detect the state of the transformer; and
a detection unit configured to detect occurrence of a power failure, based on information indicating the state of the transformer.

8. The power failure detection device according to claim 7, wherein the detection unit identifies an operating state of the transformer, based on information indicating the state of the transformer, and in a case where the transformer has stopped operation, the detection unit determines that a power failure has occurred.

9. The power failure detection device according to claim 8, wherein, in a case where the detection unit determines that a power failure has occurred, the detection unit identifies the transformer that has stopped operation and an installation position of the transformer, based on the optical signal, and identifies the installation position of the transformer as a position where the power failure has occurred.

10. The power failure detection device according to claim 9, wherein, in a case where the detection unit determines that a power failure has occurred, the detection unit identifies an area that receives power supply from the transformer that has stopped operation, and identifies the area that receives the power supply from the transformer as an area where the power failure has occurred.

11. The power failure detection device according to claim 10, further comprising a report unit configured to, in a case where the detection unit determines that a power failure has occurred, cause a display unit to display at least one of a position and an area where the power failure has occurred in an overlapping manner on a map.

12. The power failure detection device according to claim 7, wherein the information indicating the state of the transformer is information indicating at least one of a state of vibration of the transformer, a state of an operating sound of the transformer, and a state of a temperature of the transformer.

13. A power failure detection method by a power failure detection system, the method comprising:
a reception step of receiving an optical signal including information indicating a state of a transformer, from an optical fiber configured to detect the state of the transformer; and
a detection step of detecting occurrence of a power failure, based on information indicating the state of the transformer, the information being included in the optical signal.

14. The power failure detection method according to claim 13, wherein the detection step further includes identifying an operating state of the transformer, based on information indicating the state of the transformer, and in a case where the transformer has stopped operation, determining that a power failure has occurred.

15. The power failure detection method according to claim 14, wherein the detection step further includes, in a case of determining that a power failure has occurred, identifying the transformer that has stopped operation and an installation position of the transformer, based on the optical signal, and identifying the installation position of the transformer as a position where the power failure has occurred.

16. The power failure detection method according to claim 15, wherein the detection step further includes, in a case of determining that a power failure has occurred, identifying an area that receives power supply from the transformer that has stopped operation, and identifying the area that receives power supply from the transformer as an area where the power failure has occurred.

17. The power failure detection method according to claim 16, further comprising a report step of, in a case of determining that a power failure has occurred in the detection step, causing a display unit to display at least one of a position and an area where the power failure has occurred in an overlapping manner on a map.

18. The power failure detection method according to claim 13, wherein the information indicating the state of the transformer is information indicating at least one of a state of vibration of the transformer, a state of an operating sound of the transformer, and a state of a temperature of the transformer.
